(19) United States
(12) Patent Application Publication
(10) Pub. No.: US 2013/0270319 A1
(43) Pub. Date: Oct. 17, 2013

(54) FASTENER DRIVING TOOL

(71) Applicant: HILTI AKTIENGESELLSCHAFT, Schaan (LI)

(72) Inventors: Moritz GAUGER, Feldkirch (AT); Tilo Dittrich, Feldkirch (AT); Simon Beauvais, Horbranz (AT); Rolf Erhardt, Buchs SG (CH)

(73) Assignee: Hilti Aktiengesellschaft, Schaan (LI)

(21) Appl. No.: 13/860,611

(22) Filed: Apr. 11, 2013

(30) Foreign Application Priority Data
Apr. 13, 2012 (DE) 102012206108.8

(51) Int. Cl. B25C 1/08

(52) U.S. Cl. CPC B25C 1/08
USPC 227/2; 227/10

(57) ABSTRACT

The invention concerns a fastener driving tool comprising a tank for storage of a fuel, in particular liquefied gas, a combustion chamber connected to the tank, a piston that is movable in a cylinder for driving a driving ram, and at least one exhaust gas opening for ejection of exhaust gases after an ignition of a fuel/air mixture, where the development of the gas pressure of the combustion chamber is selectably reducible compared to a maximum pressure development, in order to affect a driving energy of the piston through the ejection, where, if a driving energy is reduced, the maximum pressure development after the ignition is applied over a first segment of travel of the piston.

This patent application claims the benefit of German Patent Application No. DE 102012206108.8, filed Apr. 13, 2012, which is incorporated by reference.

### TECHNICAL FIELD

The invention concerns a fastener driving tool, in particular a handheld fastener driving tool, as in the generic part of claim 1.

### BACKGROUND OF THE INVENTION

DE 40 10 517 A1 describes a gas powered fastener driving tool with a combustion chamber, a piston guided in a cylinder, and a manually adjustable exhaust gas opening in the combustion chamber to reduce fastener driving energy. When the exhaust gas opening is set to a partially or maximally opened position, a portion of the combustion gases escapes directly through the exhaust gas opening starting from the beginning of pressure buildup after ignition of a gas mixture.

### BRIEF SUMMARY OF THE INVENTION

It is the task of the invention to specify a fastener driving tool that has a variable driving energy.

For a fastener driving tool of the kind mentioned at the start, this task is solved in accordance with the invention with the characterizing features of claim 1. The piston experiences a high initial acceleration and a specific minimum velocity through the maximum pressure that is applied initially over the first segment of piston travel.

Penetration of the nail or fastener that is to be set into the surface region of a workpiece (wall, floor, wood beam, etc.), among other things, is reliably provided through this. A high piston velocity is desired for the said first segment of penetration. Apart from a high initial velocity, it is then desirable to provide a maximum or reduced driving energy in each case according to the required penetration depth (nail length, etc.) and/or material properties of the workpiece (wood, brick, cement, concrete, etc.).

The maximum pressure development in the sense of the invention is thus understood to be the timewise development of the combustion chamber pressure and thus the driving force acting on the piston that is applied without the measures that reduce the driving energy. This does not rule out, in each case according to requirements and manner of construction, that a deliberate loss of gas pressure, for example via an exhaust gas opening, may already be present upon selection of the maximum driving energy.

The gas pressure development when a reduced driving energy is selected differs in the sense of the invention from the maximum pressure development in that in the first segment of travel it essentially corresponds to the maximum pressure development and only later, thus in the further course of piston travel, drops off by comparison with the maximum pressure development.

The size of the first segment of travel of the piston can be selected in each case according to requirements. Preferably, it can amount to at least 10%, especially preferably at least 20%, of the total piston travel.

It is generally understood that the reduction of the gas pressure can take place through one or more exhaust gas openings. The measures provided in accordance with the preferred embodiments can generally be applied to exactly one and/or more than one and/or all of the exhaust gas openings.

In the case of a generally advantageous embodiment of the invention, it is provided that at least one exhaust gas opening is disposed in the region of the cylinder. Preferably in this case the piston does not unblock the exhaust gas opening until after the first segment of travel has been passed. Through this it is ensured via a simple design that the piston initially experiences an unreduced acceleration. In an especially simple and cheap form of construction, the exhaust gas opening disposed in the region of the cylinder can be selectably changed between two states of the opening, for example open/closed. Such a selection can also take place, for example, through a manual mechanical adjustment.

In the case of an alternative or additional embodiment, the exhaust gas opening can also be disposed in the region of the combustion chamber. This can be the case in particular when a specifically delayed unblocking of the exhaust gas opening takes place. In general exhaust gas openings can also be provided both in the region of the cylinder and in the region of the combustion chamber. There can also be different kinds of control of several such exhaust gas openings.

Basically, the unblocking of an exhaust gas opening in the sense of the invention can be triggered by a defined time delay and/or by a spatial position, in particular of the piston.

In a generally advantageous embodiment, the exhaust gas opening is made controllably closable. Through this, in general, the selection of the driving energy can be connected to an electronic control unit of the tool. In particular this makes it possible that an unblocking of the at least one exhaust gas opening for a reduction of the driving energy takes place after a defined time delay after ignition of the fuel-air mixture. This can be implemented, for example, through an electric control valve. Preferably, the time delay is set by the control unit. Especially preferably, the time delay is calculated by the control unit, for example on the basis of a desired driving energy, where the time delay is in particular greater, the greater the desired driving energy is, so that the maximum pressure development is maintained longer, the less the driving energy is to be reduced.

In a preferred development of the invention, in the interest of an exact choice of the driving energy, an effective cross section of the at least one exhaust gas opening is adjustably variable, in particular over a plurality of discrete steps or continuously. This also includes embodiments in which, for example, there is a plurality of exhaust gas openings that are each individually closable.

Generally advantageously, an adjustment of the driving energy can take place by means of a mechanical actuation unit. According to an advantageous embodiment, an adjustment of the driving energy can also take place by means of an electronic control unit. In the preferred detailed design a sensor element can determine an operating condition for preferably automatic adjustment of the driving energy. Such a sensor element can in the ideal case determine the property of the material of the workpiece. However, a sensor element can also be one that, for example, determines the type of loaded nail in the fastener driving tool, for example with regard to a length of the nail or other property. Further advantageously an adjustment of the driving energy is controllable via a display unit, preferably an electronic display unit, through which error settings are prevented.

### BRIEF DESCRIPTION OF THE SEVERAL VIEW OF THE DRAWINGS

Other features and advantages of the invention result from the embodiment examples and the dependent claims. A number of preferred embodiment examples of the invention are described below and described in more detail by means of the attached drawings.

FIG. 1 shows a schematic view of a first embodiment of a fastener driving tool in accordance with the invention.

FIG. 2 shows a second embodiment of the invention.

FIG. 3 shows a third embodiment of the invention.

FIG. 4 shows a fourth embodiment of the invention.

FIG. 5 shows a detail of the embodiment in FIG. 4 with a partially opened exhaust gas opening.

FIG. 6 shows the detail from FIG. 5 with fully opened exhaust gas opening.

FIG. 7 shows a modification of the detail from FIG. 5.

### DETAILED DESCRIPTION OF THE INVENTION

The fastener driving tool shown schematically in FIG. 1 comprises a housing 1, in which a combustion chamber 2 is disposed. Liquefied gas is stored as fuel in a fuel tank 5 and can be injected into the combustion chamber 2 via a line 3. Line 3 connects a metering device 4 to the combustion chamber 2, where the metering device 4 in turn is connected to the fuel tank 5, which is disposed in or on the housing 1. The fuel tank can in particular be made as a replaceable cartridge.

The fastener driving tool comprises, moreover, an electronic control unit 6 with an electric battery 6a as the energy source. A spark plug 7 in the combustion chamber 2 is triggered by means of a line 7a via the electronic control unit 6. In addition, the metering device 4 is optionally triggered, provided it has electric valves or other electrically controlled components. In a forward region of the driving tool there is a magazine 8 for storage of fasteners, for example nails. A pressure element 9 can be pressed against a workpiece in order to unblock a triggering of the fastener driving tool.

The driving of a fastener element from the magazine 8 takes place via the ignition of a liquefied gas/air mixture in the combustion chamber 2 by means of the spark plug 7, after which a piston 10 is continuously driven forward in a cylinder 11 and drives the fastener element or the nail into the workpiece via a driving ram 12. This driving operation is triggered by an operator via a switch 13, which is chiefly disposed in a handle region 14 of the housing 1. The travel of the piston 10 is limited by an elastic stop or bumper 15. Before an ignition the mixture is distributed in the combustion chamber in a known way with support from an electrically operated fan 16.

A metering of the fuel can take place by means of the metering device 4, for example, in each case according to air pressure (elevation) or other criteria. An effect on driving energy, which is possible through this within a certain range, can as needed, additionally or independently, be brought about in the manner described below.

On cylinder 11 a first exhaust gas opening 17, through which a driving energy of the piston 10 is selectably variable, is provided in a forward region. A second exhaust gas opening 18 is disposed in a region that is preferably at the back of the piston travel. The second exhaust gas opening 18 chiefly serves for ejection or flushing of combustion gases after completion of a driving operation.

The first exhaust gas opening 17 on the other hand is disposed less behind the combustion chamber 2, which is bounded by the piston 10 in an initial position of the piston (the drawing is purely schematic and not to scale). At first the passage from the combustion chamber to the exhaust gas opening 17 is blocked by the piston 10. Only after the piston has passed through a first segment of travel under full gas pressure can the combustion gas escape through the exhaust gas opening 17, provided it is open. Such an opening can be manually selectable. In each case, according to requirements, a simple adjustment to “open” (reduced driving energy) or “closed” (maximum driving energy) can be available. However, this can also be an adjustable change of the cross section, for example by means of an adjustable valve in a construction as in DE 40 10 517 A1.

If on the other hand the exhaust gas opening 17 is closed, the maximum possible gas pressure is applied over the entire piston travel (maximum pressure development), so that a maximum driving energy is also achieved.

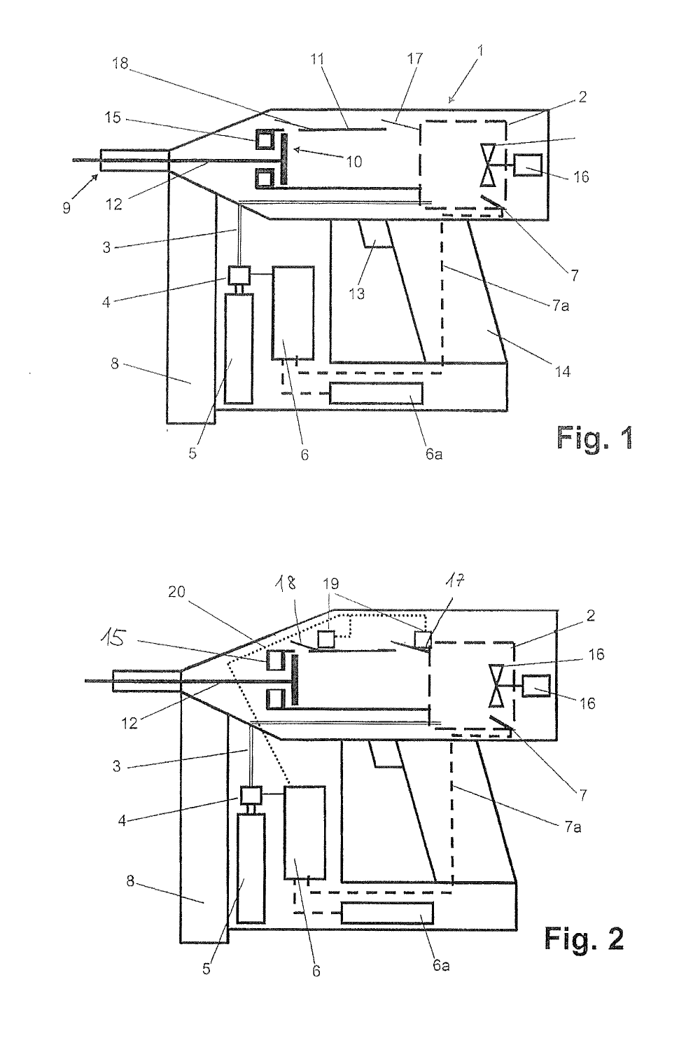

FIG. 2 shows a second embodiment of the invention, in which both gas openings 17 and 18 are selectably closable by means of controllable actuators 19. For this control lines 20 run from the control unit 6 to the actuators 19. The first exhaust gas opening 17 can be automatically actuated through this analogous with the manual case as in FIG. 1. Alternatively or additionally, however, an exact timewise control of the exhaust gas opening can be available, for example an opening delayed with respect to the time of ignition. With control of this kind the exhaust gas opening 17 can in principle also be disposed in the region of the combustion chamber 2.

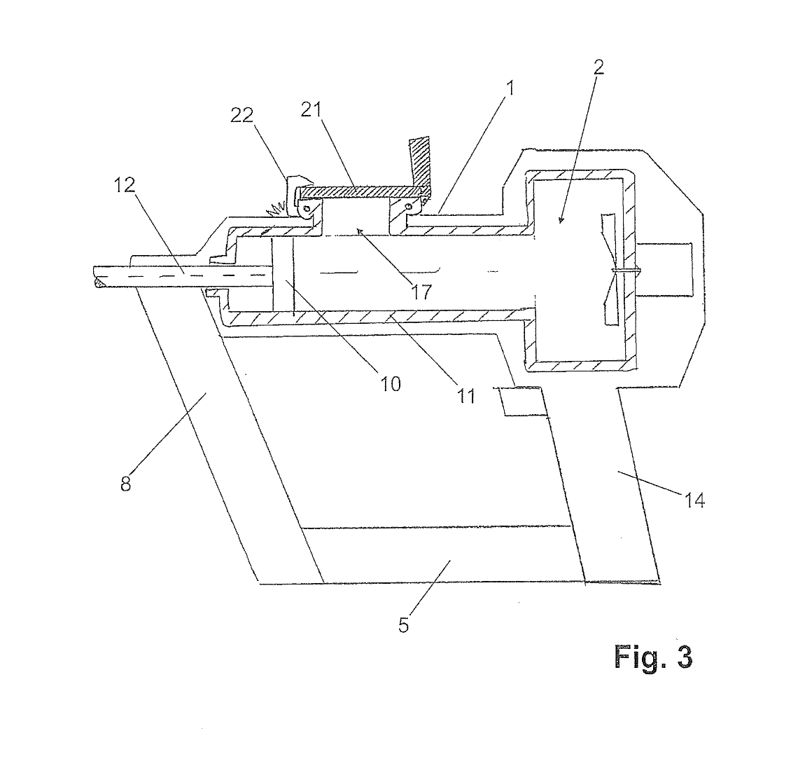

FIG. 3 shows another embodiment example, in which only one controllable exhaust gas opening 17 is present. This is, schematically, provided with a hinge mounted closure flap 21, which is kept in a closed position by a hook-shaped latch 22. The latch is controllably movable via an actuator, so that the flap 21 can be released to reduce the driving energy upon demand. Similar to the example in FIG. 1, the piston in this case blocks the passage of the gases from the combustion chamber 2 to the exhaust gas opening 17 in a first segment of travel.

The flap 21 can be spring-loaded, for example in the closure direction, so that it returns to the closed position when the gas pressure is sufficiently low. After that it acts as a check valve, so that the cooling residual gases provide for a reduced pressure in the combustion chamber, by means of which the piston 10 is returned to the starting position. This is generally the preferred principle of resetting the piston. Alternatively or additionally, however, a return spring can also be provided.

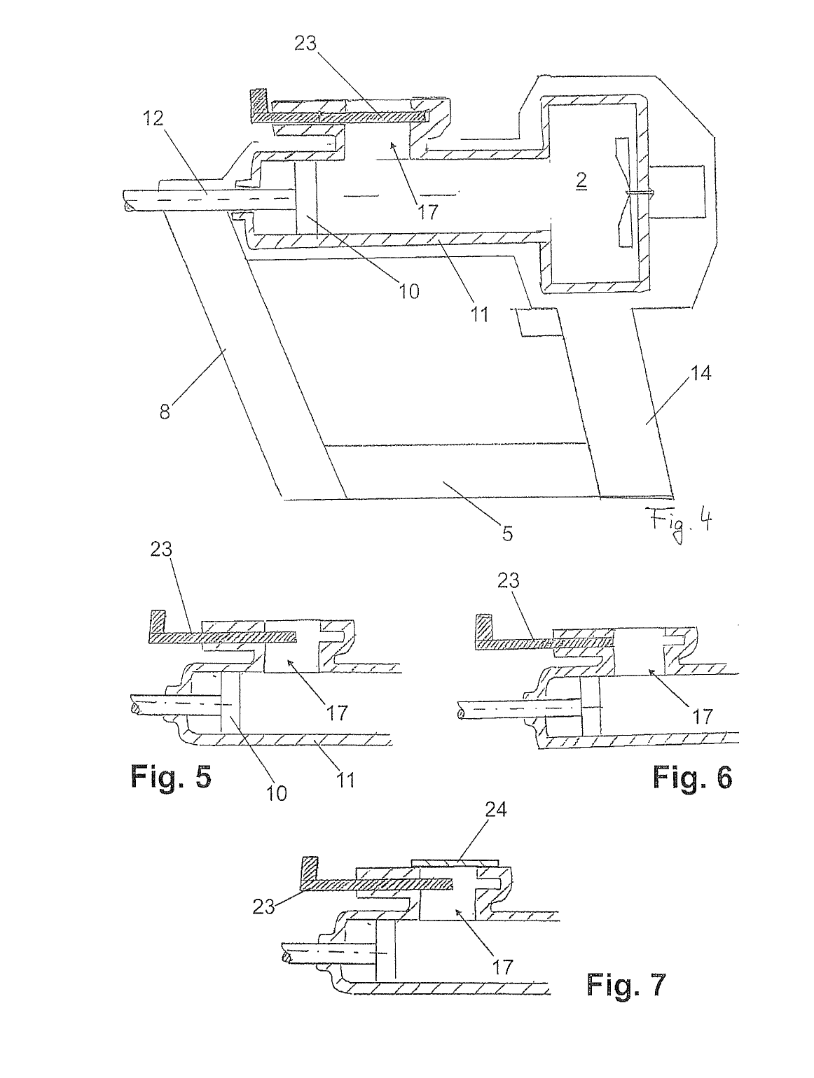

FIGS. 4 to 6 show another embodiment example of the invention, which is similar to the one in FIG. 3. In contrast to the flap valve in FIG. 3, here there is a continuously adjustable slide valve 23 over the exhaust gas opening 17. By shifting it an effective cross section of the exhaust gas opening can be changed, so that the driving energy is precisely adjustable. The slide 23 can be controllably shifted in a linear manner via an actuator (not shown). FIGS. 4 to 6 show different positions of the slide valve 23, namely closed, half open and open.

In the modification as in FIG. 7, a flap 24 lies over the exhaust gas opening, through which a check valve is formed, in addition to the slide valve from FIGS. 4 to 6. This enables a resetting of the piston 10 in a simple way, as in the preceding example, without a correspondingly rapid resetting of the slide valve 24 having to take place.

Of course, the individual features of the different embodiment examples can be meaningfully combined with each other in each case according to requirements.

1. A fastener driving tool, comprising
a tank for storage of a fuel,
a combustion chamber connected to the tank,
a piston that can be moved in a cylinder to drive a driving ram, and
at least one exhaust gas opening for ejection of exhaust gases after an ignition of a fuel/air mixture,
where a gas pressure development of the combustion chamber is selectably reducible compared to the maximum pressure development in order to affect a driving energy of the piston through the ejection, wherein
in the case of a reduced driving energy, the maximum pressure development after ignition is applied over a first segment of travel of the piston.

2. The fastener driving tool as in claim 1, wherein the exhaust gas opening is disposed in a region of the cylinder.

3. The fastener driving tool in claim 1, wherein the exhaust gas opening is disposed in the region of the combustion chamber.

4. The fastener driving tool as in claim 1, wherein the exhaust gas opening is controllably closable by an electronic control unit.

5. The fastener driving tool as in claim 4, wherein an unblocking of at least one exhaust gas opening for a reduction of the driving energy takes place after a defined time delay after the ignition of the fuel/air mixture.

6. The fastener driving tool as in claim 5, wherein that time delay is specified by the control unit.

7. The fastener driving tool as in claim 6, wherein the time delay is calculated by the control unit.

8. The fastener driving tool as in claim 4, wherein an effective cross section of the at least one exhaust gas opening is adjustably variable.

9. The fastener tool as in claim 4, wherein an adjustment of the driving energy takes place by means of a mechanical actuation unit.

10. The fastener driving tool as in claim 4, wherein an adjustment of the driving energy takes place by means of an electronic control unit.

11. The fastener driving tool as in claim 10, wherein a sensor element determines an operating condition for adjustment of the driving energy.

12. The fastener driving tool as in claim 1, wherein an adjustment of the driving energy is controllable via a display unit.

13. The fastener driving tool as in claim 2, wherein the exhaust gas opening is disposed in the region of the cylinder where the piston does not unblock the exhaust gas opening until after the first segment of travel.

14. The fastener driving tool as in claim 7, wherein the time delay is calculated on the basis of a desired driving energy.

15. The fastener driving tool as in claim 8, wherein the effective cross section of the at least one exhaust gas opening is adjustably variable via a plurality of discrete steps or continuously.

16. The fastener driving tool as in claim 11, wherein the sensor element determines an operating condition for automatic adjustment of the driving energy.

17. The fastener driving tool as in claim 12, wherein the adjustment of the driving energy is controllable via an electronic display unit.

18. The fastener driving tool as in claim 4, wherein an adjustment of the driving energy is controllable via a display unit.

19. The fastener driving tool as in claim 2, wherein the exhaust gas opening is disposed in the region of the cylinder where the piston does not unblock the exhaust gas opening until after the first segment of travel.

20. The fastener driving tool as in claim 3, wherein the exhaust gas opening is controllably closable by an electronic control unit.
